(19) United States
(12) Patent Application Publication
(10) Pub. No.: US 2007/0175348 A1
(43) Pub. Date: Aug. 2, 2007

(54) "Device,kit and method for cleaning rolls in printing machines"

(76) Inventor: Stefano Petri, Capannori (IT)

Correspondence Address: MCGLEW & TUTTLE, PC, P.O. BOX 9227, SCARBOROUGH STATION, SCARBOROUGH, NY, 10510-9227, US

(21) Appl. No.: 10/598,624

(22) PCT Filed: Feb. 28, 2005
(86) PCT No.: PCT/IT05/00109

§ 371 Date: Sep. 6, 2006

(30) Foreign Application Priority Data
Mar. 4, 2004 (IT) FI2004A000051

(51) Int. Cl. B41F 35/00

(52) U.S. Cl. 101/424

(57) ABSTRACT

Device for cleaning rolls in printing machines, specially machines for executing prints on web-shaped paper-like material destined to the production of tissue paper, napkins, toilet paper and the like, characterized by the fact that it comprises: a nozzle (1) apt to direct a steam jet toward the surface of a roll (2, 3) to be cleaned: said nozzle (1) being connected to steam feeding means; a suction chamber (5) within which is disposed said nozzle (1) and apt to execute an aspiration in correspondence of the surface of the roll (2, 3) interested by the steam et supplied by the nozzle (1): said chamber (5) being connected to relevant suction means; a plurality of holes (7, 8) oriented toward the surface of the roll (2, 3) to be cleaned, and connected to air compressed feeding means.

The present invention refers to a device, a kit and a method for cleaning rolls in printing machines, especially machines for executing prints on web-shaped paper material destined to the production of tissue paper, handkerchiefs, toilet paper and the like.

It is known that the printing machines, and particularly those employed for executing prints on materials of the aforesaid type, comprise at least a driving cylinder around which the web-shaped material to be printed travels and at least a cliché roll on which the ink is distributed. The ink is distributed on the cliché roll by a so called screened roll, or “anilox” roll, disposed between the same cliché roll and an ink reservoir. During the printing, the web-shaped material travels between the surface of the driving roll and the inked surface of the cliché roll: said driving roll and said cliché roll rotating around the respective longitudinal axis, which are parallel to each other, and their rotation involves the advancing of the web-shaped material. A printing machine of this type is described, for example, in WO 01/54909.

It is also known that both the cliché roll and the anilox roll are subject to paper-dust formations and, more in general, also by masses of partially dried ink which, if not timely removed, determine a progressive and drastic reduction of the printing quality.

Therefore, cleaning devices are used which are provided with a nozzle delivering a pressurized fluid, i.e. compressed air or pressurized water, oriented toward the surface of the roll to be cleaned. These devices are provided also with a suction section through which the fluid with the dirt removed from the roll surface is sucked, and thus moved away. A cleaning device utilizing compressed air is described in JP-63004947. A cleaning device utilizing pressurized water is described in IT-FI/95/A/137.

Both the cleaning devices utilizing compressed air and the devices utilizing pressurized water have drawbacks that make them not suitable for the present production requirements. More particularly, relating to the compressed air devices, the action of the air is practically insufficient or ineffective, especially with respect to the dry ink residuals. This drawback is even more evident when certain types of ink are used which exhibit a more strong adherence to the roll surface.

The device utilizing pressurized water determine an excessive water consumption, with the necessity of an expensive depuration of the water before its re-utilization or the discharge. However, the recycling of the water is limited by the fact that the concentration of the removed substances from the cleaned rolls progressively increases during the operations, until the recycled water is no longer usable. The main object of the present invention is to eliminate or at least strongly reduce the said drawbacks.

This result has been achieved, according to the invention, by adopting the idea of a device, a method and a kit having the characteristics described in the independent claims. Further characteristics being set forth in the dependent claims.

The advantages deriving form the present invention lies in that it is possible, by utilizing steam, to drastically reduce the consumption of the water utilized for cleaning the rolls and to expedite the drying of the same, without compromising the effectiveness of the thus executed cleaning and, consequently, the printing quality. Experimental tests executed by the inventor have ascertained that, in the same conditions (i.e. length and surface of the roll, translation speed of the nozzle along the roll surface, type of ink, etc.) the steam production requires an amount of water about 20-30 less than the amount of water utilized by a known water cleaning device.

Another advantage derives from that the heat of the steam contributes synergically to increase the mechanical cleaning effect due to the impact of the steam on the surface of the roll. Advantageously, it is possible to increase the cleaning action by adding a detergent to the liquid from which is formed the steam.

Moreover, a device according to the invention is relatively easy to make, cost-effective and reliable even after a prolonged service life.

These and other advantages and characteristics of the invention will be best understood by anyone skilled in the art from a reading of the following description in conjunction with the attached drawings given as a practical exemplification of the invention, but not to be considered in a limitative sense, wherein:

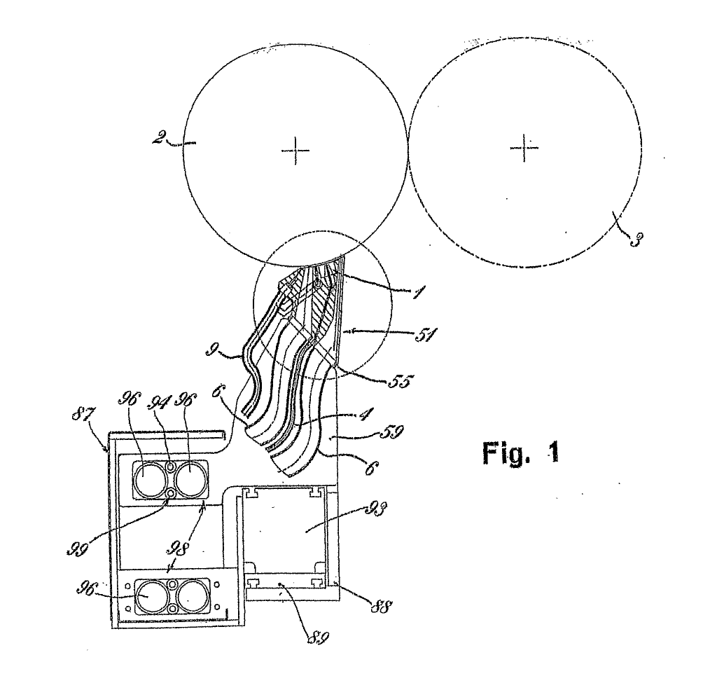

FIG. 1 is a schematic cross sectional view of a device according to the invention, acting on the surface of a cliché roll;

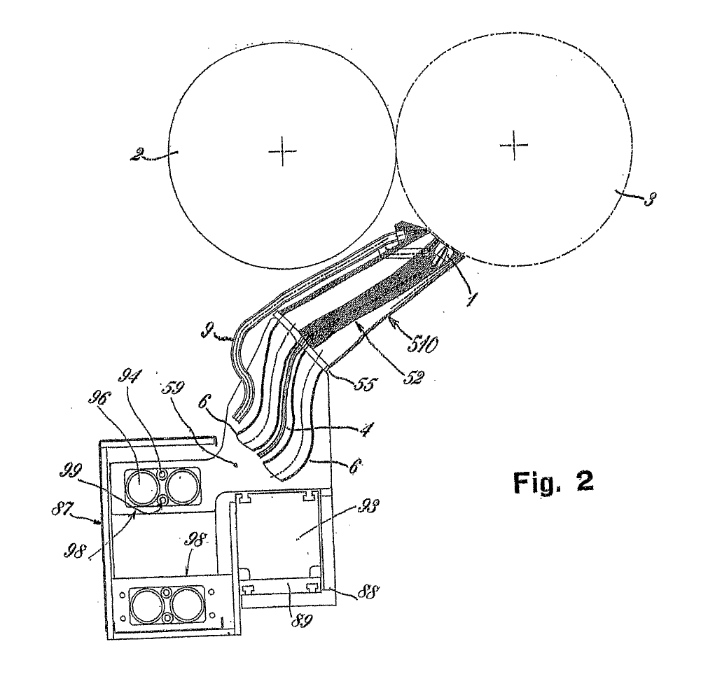

FIG. 2 is a schematic cross sectional view of a device according to the invention, acting on the surface of an anilox roll;

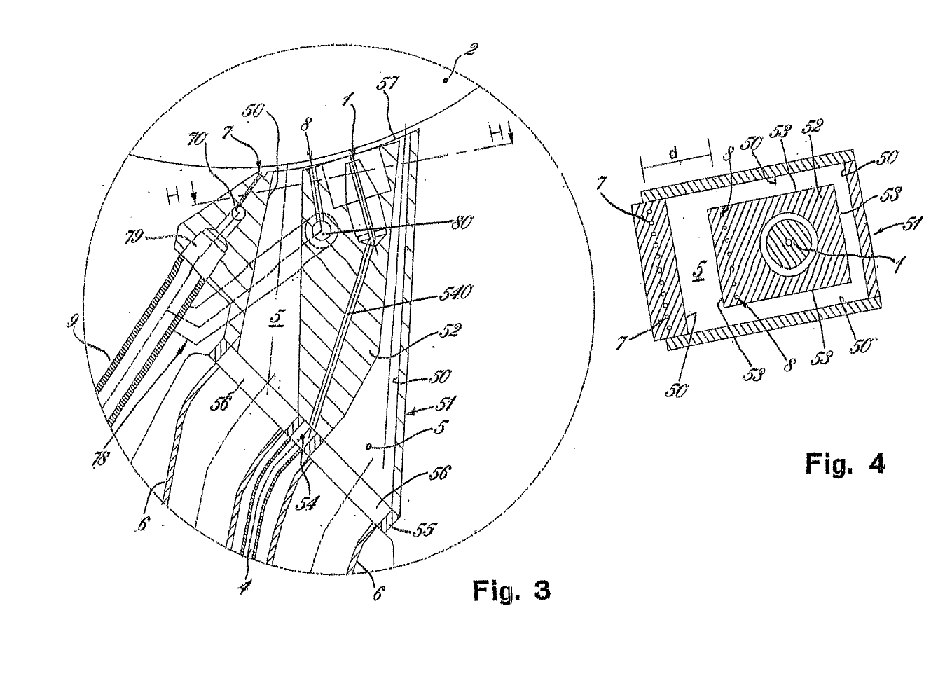

FIG. 3 shows an enlarged particular of FIG. 1;

FIG. 4 is a sectional view according to the line H-H of FIG. 3.

Reduced to its basic structure, and reference being made to the figures of the attached drawings, a device for cleaning cliché or anilox rolls in machines for executing prints on web-shaped paper-like material according to the invention comprises:
a nozzle (1) apt to direct a steam jet toward the surface of a cliché roll (2) or of an anilox roll (3): said nozzle (1) being fed by steam feeding means through a respective flexible tube (4);
an suction chamber (5) within which is disposed said nozzle (1) and apt to provide a suction effect in correspondence of the surface of the cliché roll (2) or of the anilox roll (3) interested by the steam jet supplied by the nozzle (1): said chamber (5) being connected to suction means by one or more flexible tubes (6).

Ink is distributed on said rolls (2, 3) in a traditional manner.

More in particular, referring to the example of the annexed drawings, said suction chamber (5) is delimited by the inner lateral walls (50) of a first box-shaped body (51; 510) and by the outer lateral walls (53) of a second body (52) which is internal to the first body (51; 510) and which acts as a support for the nozzle (1). A base (55) of said chamber (5) is delimited by a surface provided with two apertures (56) for connecting it to the suction ducts (6) and further provided with an aperture (54) for connecting it to the said duct (4). The aperture (54) for the steam supplying duct is in a substantially central position in respect to the other two apertures (56) and constitutes an end section of a duct (540) internal to said second body (52) which, on the opposite side, is connected to the nozzle (1), so that the steam reaches the latter through the duct (4), the aperture (54) and the duct (540). The other base (57) of the chamber (5), i.e. the base opposite to the base on which the ducts (4) and (6) are connected, is open and it features a substantially arc-shaped outline whose radius is slightly greater than the radius of the cliché and anilox rolls (2, 3); the concavity of said base (57) destined to face the surface of one of the two rolls (2, 3) leaving a short gap between the same base and the roll.

Said apertures (54, 56, 79) are fast coupling connections which allow to provide the cleaning device of the invention with a cleaning head (51; 510) suitably shaped in respect to the roll to be cleaned. The fast coupling system allows to associate a main body (59) of the device to a cleaning head (51; 510), with the relevant link between the connections provided on the main body (59) and the correspondent supplying and aspirating ducts provided on the cleaning heads. Referring to the not limiting example shown in the drawings, there are two cleaning heads, marked with (51) and (510) and respectively shaped in order to allow the cleaning of the cliché roll (2) and of the anilox roll (3); in practice, it is possible to associate, to a main body (59) of the device (the movement of which will de described later), alternatively the cleaning head (51) for the cliché roll, or the cleaning head (510) for the anilox roll, without modifying neither the positioning nor the movement means of the system. In the shown embodiment, the cleaning head (51) for the cliché roll (2) has a length smaller than the other head (510); obviously, the dimensions can vary according to the dimensions and the positioning of the parts to be cleaned. Moreover, what said relating to the dimensions of the cleaning heads (51; 510) concerns not only the respective external walls or structures but also the respective internal elements.

Advantageously, both said first body (51) and the second body (52) have, in correspondence of the said open base (57) of the chamber (5), a plurality of holes (7, 8) facing the surface of the roll (2, 3) to be cleaned, and connected to compressed air supplying means by a corresponding flexible duct (9). More in particular, the holes (7) of the first body (51; 510) are connected to a first distribution chamber (70) developed transversally to the same holes, i.e. parallel to the axis of the cliché and anilox rolls (2, 3). Said distribution chamber (70) is supplied by the duct (9) through a corresponding connecting joint (79). And the holes (8) of the second body (52) are connected to a second distribution chamber (80) parallel to said first chamber (70) and supplied by the duct (9) through a corresponding offtake (78). Said holes (7, 8) for the outlet of the compressed air are aligned according to two corresponding planes, forming, in this way, two compressed air supplying fronts which are on the same side in respect to the nozzle (1) supported by the second body (52); the holes are oriented toward the surface of the roll to be cleaned ad are spaced to each other of a predetermined amount (d). More particularly, said fronts formed by the holes (7, 8) are downstream of the nozzle (1) in respect to the rotation direction of the cliché roll (2). The compressed air directed to the surface of the roll in treatment cooperates with the steam, for cleaning said surface, contributing to ensure a greater and more effective cleaning effect.

The main body (59) of the device of the invention is mounted on a guide (93) which is developed parallel to the rolls to be cleaned. In practice, the body (59), by means of a plate (88), is made solid to a carriage (89) which, in a traditional manner, is bi-directionally movable along said guide (93), driven by relevant motor means of known type, not shown. Preferably, the carriage (89) is moved bi-directionally along the guide (93) while the roll (2, 3) to be cleaned is in rotation, also when the interested roll is operative, i.e. during the printing. The translation speed of the carriage is related to the rotation speed of the relevant roll to be cleaned.

A cable carrier (98), of known type, is connected to said body (59); supplying ducts are disposed inside said carrier. In particular, within the cable carrier (98), which is covered by an external protection (87), are provided two suction tubes (96), connected to said ducts (6), a tube (94) for supplying the steam, connected to said duct (4), and a tube (99) for compressed air, connected to said duct (9).

According to the present invention is therefore provided a method for the cleaning of rolls, especially for printing machines used for web-shaped paper-like material destined to the production of tissue paper, napkins, toilet paper and the like. According to the present method, provision is made for cleaning the roll by means of a steam jet directed to the roll surface and suction of the particles thus removed from the roll surface.

Advantageously, the steam jet can be continuous or discontinuous; in the latter case, especially for relatively low speed of rotation of the rolls, the roll surface is “hammered”, thus producing an advantageous cleaning effect. In other words, the continuousness or discontinuousness of the steam jet can be decided according to the chosen cleaning procedure.

Moreover, it is possible to add to the liquid to be vaporised a detergent, of known type, for further increasing the cleaning action of the system.

The moving, driving and controlling means of the above mentioned elements are known to those skilled in the industrial automation field and will not, therefore, be described in greater detail.

The construction details may vary in any equivalent way as far as the shape, dimensions, elements disposition, nature of the used materials are concerned, without nevertheless departing from the scope of the adopted solution idea and, thereby, remaining within the limits of the protection granted to the present patent.

1. Device for cleaning rolls in printing machines, especially machines for executing prints on web-shaped paper-like material destined to the production of tissue paper, napkins, toilet paper and the like, comprising:
a nozzle apt to direct a steam jet toward the surface of a roll to be cleaned: said nozzle being connected to steam feeding means;
a suction chambers within which is disposed said nozzle and apt to execute an aspiration in correspondence of the surface of the roll interested by the steam jet supplied by the nozzle said chamber being connected to relevant suction means;
a plurality of holes oriented toward the surface of the roll to be cleaned, and connected to air compressed feeding means;
characterized by the fact that said suction chamber is delimited by the lateral inner walls of a first box-shaped body and by the lateral outer walls of a second body which is internal to the first body and which acts as a support for the said nozzle and by the fact that a base of said chamber is delimited by a surface provided with two apertures for connecting it to relevant aspiration ducts and with an aperture for connecting it to a steam duct.

2. Device according to claim 1, characterized by the fact that said plurality of holes is disposed along two rows, with the holes of each row aligned according a corresponding plane, forming, in such way, two supplying fronts for the compressed air which are on the same side in respect to the nozzle.

3. Device according to claim 1, characterized by the fact that it comprises a main body provided with fast coupling means for fixing, one at a time, different cleaning heads destined to a corresponding roll to be cleaned.

4. Device according to claim 3, characterized by the fact that said main body is supported by a carriage bi-directionally movable along a guide parallel to the roll to be cleaned.

5. Device according to claim 1, characterized by the fact that said first body and said second body have, in correspondence of the open base of the chamber, a plurality of holes facing the surface of the roll to be cleaned and connected to compressed air supplying means by a corresponding flexible duct the holes of the first body being connected to a first distribution chamber which is developed transversally to the same holes and is supplied by a duct through a corresponding connecting joint the holes of the second body being connected to a second distribution chamber which is parallel to said first chamber and is supplied by said duct through a corresponding offtake, said holes for the outlet of the compressed air being aligned according to two corresponding planes, forming, two compressed air supplying fronts on the same side in respect to the nozzle supported by the second body.

6-13. (canceled)
